(19) United States
(12) Patent Application Publication
(10) Pub. No.: US 2024/0354903 A1
(43) Pub. Date: Oct. 24, 2024

(54) SINGLE-SUBJECT IMAGE GENERATION

(71) Applicant: Unity Technologies SF, San Francisco, CA (US)

(72) Inventor: Alexander Robert Reid, Stirling (CA)

(21) Appl. No.: 18/645,333

(22) Filed: Apr. 24, 2024

Related U.S. Application Data
(60) Provisional application No. 63/461,570, filed on Apr. 24, 2023.

(51) Int. Cl. G06T 5/50; G06T 7/194; G06T 13/80

(52) U.S. Cl. CPC G06T 5/50; G06T 7/194; G06T 13/80; G06T 2207/20224

(57) ABSTRACT

A method of generating an image is disclosed. A mask and descriptive text associated with a subject are received. The descriptive text comprises a text prompt. The mask is resized to fit within a predefined bounding box and the resized mask is centered on a background image. The centered mask is filled with noise. Output of an image of the subject on a solid background is received from a generative AI model in response to a passing of a request to the generative AI model. The request includes the noise-filled mask and the descriptive text.

### CROSS-REFERENCE TO RELATED APPLICATIONS

This application claims the benefit of U.S. Provisional Application No. 63/461,570, filed Apr. 24, 2023, which is incorporated by reference herein in its entirety.

### TECHNICAL FIELD

The subject matter disclosed herein generally relates to the technical field of computer graphics systems, and, in one specific example, to computer systems and methods for generating single-subject images and sprites.

### BACKGROUND

In the world of computer graphics and content generation, it can be difficult to efficiently produce a photorealistic image of a desired subject on a solid background.

### BRIEF DESCRIPTION OF THE DRAWINGS

Features and advantages of example embodiments of the present disclosure will become apparent from the following detailed description, taken in combination with the appended drawings, in which:

FIG. 1 is a flow chart of example operations for generating a photorealistic image of a desired subject on a solid background;

FIG. 2 is a flow chart of example operations for converting a photorealistic image to a sprite;

FIG. 3A is screenshot of an example of converting text to an image;

FIG. 3B is a diagram of a conversion of a first image into a second image, in accordance with some embodiments;

FIG. 3C is a diagram of a conversion of a text and mask to a single subject image or sprite, in accordance with some embodiments;

FIG. 3D is a diagram of a flow for generating a photorealistic image with a particular style, in accordance with some embodiments;

FIG. 3E is a diagram of a flow for creating similar variations of a sprite in a particular style or converting an input image to a particular style, in accordance with some embodiments;

FIG. 3F is a diagram of a flow for extracting a subject from an image and converting it to a particular style, in accordance with some embodiments;

FIG. 4 is a block diagram illustrating an example software architecture, which may be used in conjunction with various hardware architectures described herein; and

FIG. 5 is a block diagram illustrating components of a machine, according to some example embodiments, configured to read instructions from a machine-readable medium (e.g., a machine-readable storage medium) and perform any one or more of the methodologies discussed herein.

FIG. 6 is an example photorealistic image generated using one or more of the operations described herein.

FIG. 7 is the example photorealistic image of FIG. 6 with a particular style applied using one or more of the operations described herein.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the disclosed subject matter. It will be evident, however, to those skilled in the art, that various embodiments of the disclosed subject matter may be practiced without these specific details.

The present disclosure includes one or more apparatuses configured to perform one or more operations or one or more combinations of operations described herein, including data processing systems which perform these operations and computer readable media, which, when executed on data processing systems, cause the systems to perform these operations, the operations or combinations of operations including non-routine and unconventional operations or combinations of operations.

The systems and methods described herein include one or more components or operations that are non-routine or unconventional individually or when combined with one or more additional components or operations, because, for example, they provide a number of valuable benefits to digital content creators: for example, the methods and systems described herein allow for efficient generation of a photorealistic image of a desired subject on a solid background and/or for use as a sprite (e.g., a digital object that may be moved or otherwise manipulated as a single entity within an environment).

In example embodiments, a generative AI model is used to output images. By providing specially crafted input images to the generative model, it is possible to cause the generative AI model to output a photorealistic image of a desired subject on a solid background. In example embodiments, the generated output images have a format that can be easily and reliably converted into sprites having any art style. Throughout the description herein, the term photorealistic refers to a quality of a generated output image (or part thereof) being substantially indistinguishable (e.g., within a configurable or predetermined photorealism threshold) from a real photograph, particularly from a perspective of a human observer. This includes lighting and/or textures of a quality that resemble (e.g., within a configurable or predetermined quality threshold) what might be seen in a photograph of the desired subject in a real-life environment (e.g., despite the desired subject being on a mono-color (e.g., black) background in the generated output). In accordance with an embodiment, despite an output image of the desired subject being photorealistic (e.g., having a realistic look), the desired subject of the image may still have non-realistic features, such as an extra finger of arm on a person.

In example embodiments, the operations allow for generation of sprites from an idea within a very short period of time, which, in turn, may significantly enhance the quality and/or quantity of digital assets available for deployment within one or more environments.

A method of generating an image is disclosed. A mask and descriptive text associated with a subject are received. The descriptive text comprises a text prompt. The mask is resized to fit within a predefined bounding box and the resized mask is centered on a background image. The centered mask is filled with noise. Output of an image of the subject on a solid background is received from a generative AI model in response to a passing of a request to the generative AI model. The request includes the noise-filled mask and the descriptive text.

In example embodiments, a system is configured to receive a mask and descriptive text. The mask may be a binary or grayscale image that delineates the area for the subject's image generation. The descriptive text, formatted as a text prompt, specifies semantic attributes of the subject to guide the AI model. The mask may be resized to fit a predefined bounding box, ensuring it is proportionate to the intended image dimensions. An algorithm may be employed to center the resized mask on a background image, which acts as the canvas for image generation.

To introduce textural detail into the image, the centered mask is filled with structured noise. This noise is algorithmically generated to simulate natural variations in texture and lighting, tailored to the subject's requirements. The type and intensity of noise are adjustable based on the subject's characteristics, such as required smoothness or irregularity.

The noise-filled mask and descriptive text are then passed to a generative AI model. This model, based on a deep neural network trained with extensive image and text datasets, synthesizes a new image that aligns with the input descriptions while populating the details within the mask's confines. The architecture of the AI model is designed to process complex text-visual interactions, ensuring the output is both contextually appropriate and photorealistic.

The output from the AI model is a photorealistic image presented on a solid background, conforming to predefined photorealism standards including resolution, color fidelity, and detail accuracy. This output is suitable for use across various professional digital media applications.

In example embodiments, a system regenerates a photorealistic image with a specific art style applied. A secondary machine-learning model that has been trained on that particular style may be used. This process may involve the integration of a style transfer algorithm that is capable of imposing the artistic characteristics of the selected style onto the base photorealistic image. The secondary machine-learning model, which is distinct from the primary generative AI model used to create the initial photorealistic image, is specifically trained with a dataset comprising examples of the target art style. This training enables the model to learn the unique elements and techniques characteristic of the style, such as brush strokes, color palettes, and textural details.

An original photorealistic image is input into the secondary model. The model then analyzes the image and is applied (e.g., in a series of convolutional neural network (CNN) layers that progressively modify the image's attributes) to align with the learned artistic style. These layers adjust various aspects of the image such as texture, edge definition, and color modulation to transform the photorealistic image into one that adheres to the aesthetic principles of the chosen art style.

To ensure the integrity and quality of the transformed image, the system may employ one or more optimization techniques that minimize the loss between the style features of the target art style and the generated image. This may be achieved through a loss function that balances content preservation with style infusion, ensuring that while the image adopts a new style, it still retains the original subject's recognizability and detail.

The output from this process is a stylized image that maintains the photorealistic detail of the original while exhibiting the artistic flair of the selected style. This capability may be particularly valuable in fields such as digital media, advertising, and virtual reality, where visually compelling content is important.

In example embodiments, distinct functionalities facilitated are facilitated by different models (e.g., a primary generative AI model for creating photorealistic images and/or a secondary machine-learning model for applying specific art styles to these images). In example embodiments, each model may undergo a two-step training process tailored to optimize their respective capabilities.

For example, a first step of a training of a primary generative AI model may involve foundational training with a diverse dataset that includes a wide array of images, masks, and descriptive texts. This phase focuses on teaching the model to accurately interpret and synthesize photorealistic images from the provided inputs. The model learns to understand the nuances of texture, lighting, and spatial relationships as described by the masks and texts, establishing a base capability in generating detailed and contextually accurate images.

The second step of the training for the primary model may involve refinement with a specialized dataset comprising complex and high-quality photorealistic images. This advanced training may be designed to enhance the model's ability to handle intricate details and challenging scenarios that require a higher level of visual fidelity. The refinement phase fine-tunes the model's parameters to improve its precision and adaptability in producing photorealistic outputs under varied conditions.

Similarly, an initial training phase for a secondary machine-learning model may focus on fundamental aspects of various artistic styles. The model may be trained with a broad selection of images representing different art styles to learn the characteristic elements such as brush strokes, color palettes, and textural effects. This foundational training may equip the model with the ability to identify and replicate basic stylistic features.

A second step in the training of the secondary model may involve a targeted refinement phase using a curated dataset of artistically styled photorealistic images. This dataset challenges the model with complex artistic transformations, requiring a nuanced application of styles that complement the underlying photorealism. The refinement training may enhance the model's capability to apply art styles in a manner that respects and enhances the original image details, ensuring that the style application is both aesthetically pleasing and faithful to the artistic intent.

While a two-step training process for each model to optimize their functionalities, in some example embodiments, one or more models can also be effectively trained using a single-step process depending on the specific requirements and constraints.

In scenarios where rapid deployment is necessary or when sufficient training data that encompasses a wide range of scenarios is available, a single-step training process may be employed for each model. This process involves training the models on a comprehensive dataset that includes both basic and complex examples, effectively combining the foundational and refinement phases into one streamlined training session.

For example, for a primary generative AI model, a single-step training would involve using a dataset that already includes a variety of photorealistic images along with their corresponding masks and descriptive texts that cover a broad spectrum of complexities and details. This approach allows the model to learn and adapt to generating high-quality images in a more direct and potentially faster manner.

Similarly, for a secondary machine-learning model, the single-step training would utilize a dataset comprising various art styles applied to photorealistic images. This dataset would be rich enough to teach the model not only the basic elements of different art styles but also how to apply these styles to complex images without compromising the photorealism.

In example embodiments, the single-step training process offers several advantages, including reduced training time and resource utilization. It simplifies the training pipeline and can be particularly beneficial in situations where computational resources or time are limited. Moreover, when high-quality, comprehensive datasets are available, single-step training can efficiently prepare the models to perform their tasks with high accuracy.

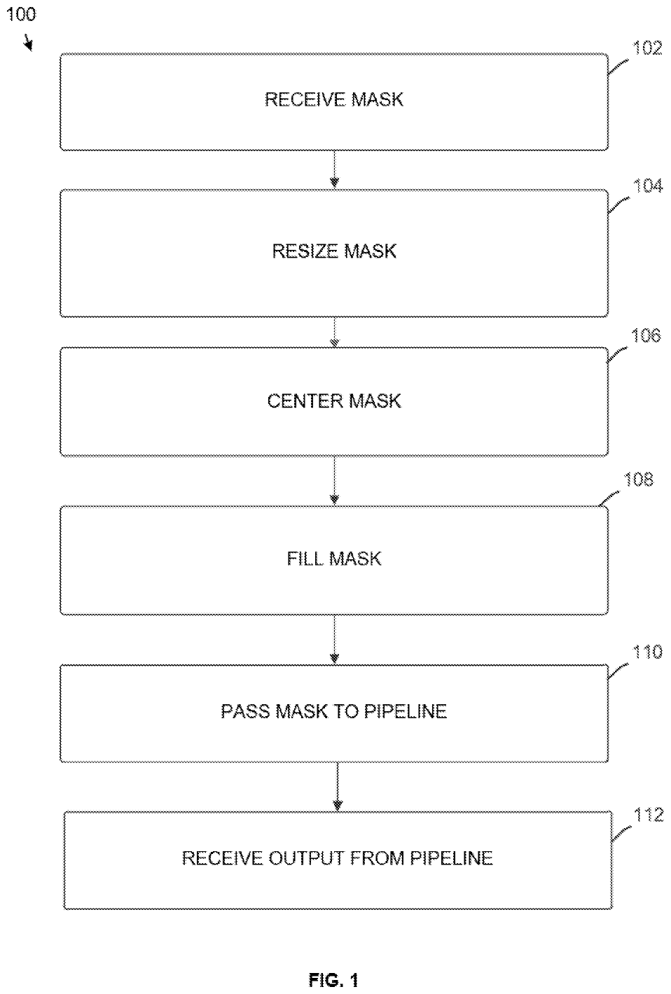

FIG. 1 is a flow chart of example operations for generating a photorealistic image of a desired subject on a solid background. In example embodiments, one or more of the example operations are embodied as one or more instructions performed by one or more computer processors.

At 102, a mask and/or descriptive text (e.g., a text prompt) is received. For example, a user sends descriptive text “an image of a hamburger” in addition to a white circle as a mask for the image of the hamburger. In accordance with an embodiment, the mask may be more detailed, outlining a shape closer to a shape consistent with an image of the hamburger. In accordance with an embodiment, the mask may be hand drawn by a user via a user interface (e.g., using a mouse or a touchscreen).

At 104, the mask may be resized to fit within a bounding box (e.g., 768×768 dimensions).

At 106, the mask may be centered on an image having a large size (e.g., a black image having 1024×1024 dimensions.

At 108, the mask is filled with semi-random colors. For example, the mask may be filled with noise. In accordance with an embodiment, the color of the noise may cause different effects on a final output photorealistic image (e.g., due to processing in operation 110 described below). For example, brighter noise may produce brighter outputs, and/or using only specific colors in the noise may cause output images to be weighted towards those colors.

At 110, the mask is passed to an image-to-image pipeline, such as an AI generative model (e.g., Stable Diffusion). In example embodiments, the mask is passed to the AI model along with the received text description (e.g., a text prompt).

At 112, output is received from the image-to-image pipeline. The output includes a photorealistic version of the image on a substantially-perfect background (e.g., within a configurable or predetermined background-perfection threshold). In example embodiments, the image can be used as-is or converted to a specific art style. For example, the output image may be converted to a specific art style by taking the photorealistic image and regenerating the image using a secondary machine learning model that has been trained on the specific art style. In this example, a second prompt “a photo of a hamburger in the style of <custom keyword>” may be used.

In accordance with an embodiment, operations 102 through 112 may be used to modify a part of an existing image. For example, during operation 102, a mask may be provided by drawing on a part of the existing image, wherein the drawing provides an outline (e.g., boundaries) of the mask. The mask (e.g., and any provided text prompt) may then be processed via operations 104, 106, 108 and 110 to create an output image for the part of the existing image covered by the mask. The output image from operation 110 (e.g., representing the part of the existing image covered by the mask) may then be composited with the existing image to create a new image. For example, a mask with the shape of a hat may be drawn on an existing image of a dog. The mask in the shape of the hat may then be separated from the image of the dog and processed via operations 104, 106, 108 and 110 to generate an image of a hat, which is then composited onto the image of the dog in the location defined by the mask.

In accordance with an embodiment, a substantially-perfect background is a background wherein the included pixels are within a configurable range of a target color such that they may be visually indistinguishable (e.g., within a predetermined or configurable background-perfection threshold) from the target color from a human perspective. For example, a perfect black background would be all pixels that are considered part of the background to have RGB (red/green/blue) pixel values equal to 0,0,0; whereas a substantially-perfect black background (e.g., that may appear substantially visually perfect to a human), may have RGB values ranging from 0,0,0 to 10,10,10 (e.g., wherein the difference in RGB values may be substantially undetectable to the human eye).

FIG. 1 outlines a flow for generating photorealistic images, initiated by the acquisition of a mask and associated descriptive text, which serves as a directive for the AI's computational process. The resizing of the mask adjusts its dimensions to fit a predefined bounding box, ensuring proper scaling and alignment on the background image. The infusion of noise introduces stochastic elements into the mask, which are useful for the AI model to effectively simulate textural depth and detail in the image synthesis. The parameters of the noise, such as granularity and chromatic variation, can be finely tuned to influence the visual qualities of the resultant image. This noise-enhanced mask is then processed by the AI generative model, which interprets the combined input of the textured mask and the descriptive prompt to synthesize the final image. The output is a high-resolution image that closely mimics photographic realism, suitable for integration into digital media or further post-processing for specific visual applications. This methodical approach facilitates the efficient production of consistently high-quality photorealistic images, tailored to meet the demands of professional digital content creation.

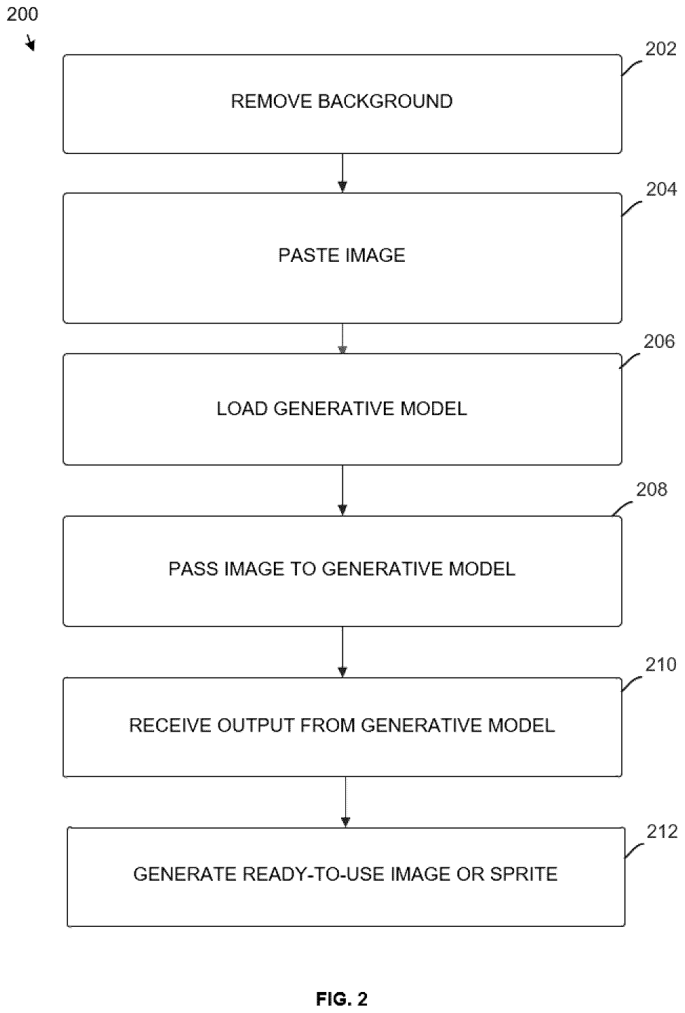

FIG. 2 is a flow chart of example operations for converting a photorealistic image, such as the image generated using the operations described in FIG. 1, to a sprite. In example embodiments, one or more of the example operations are embodied as one or more instructions performed by one or more computer processors.

At operation 202, the substantially-perfect background is removed.

At operation 204, the image is pasted back on top of the substantially-perfect background, such as a mono-color (e.g., black) background.

At operation 206, an AI generative model containing a desired art style is loaded.

At operation 208, the image is passed to the AI generative model. In accordance with an embodiment, a descriptive text (e.g., a prompt) is provided with the image. The descriptive text may describe a subject of the image and/or the desired style.

At operation 210, output is received from the AI generative model. In example embodiments, the output is the image on the substantially-perfect background with the desired style applied.

At operation 212, the substantially-perfect background is removed, resulting in a ready-to-use sprite.

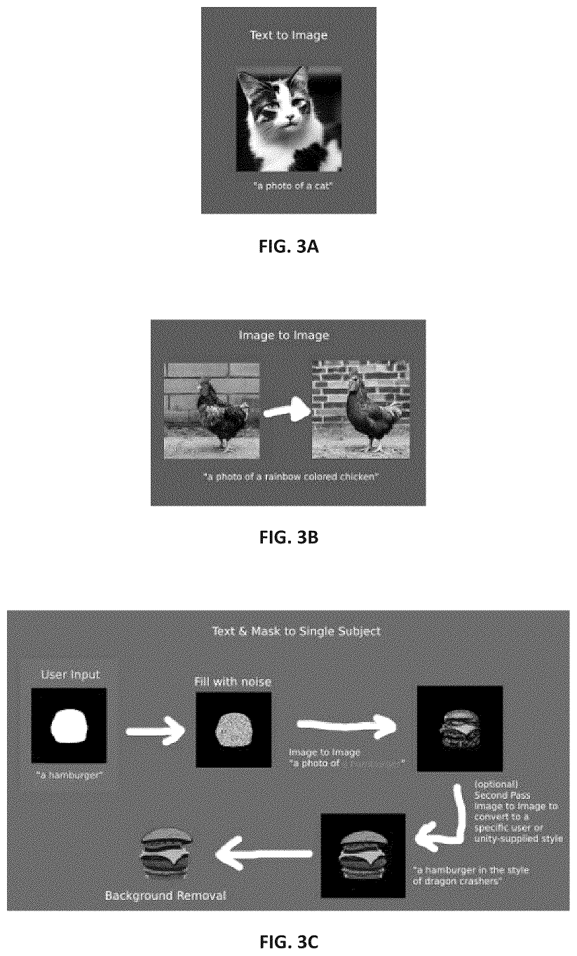

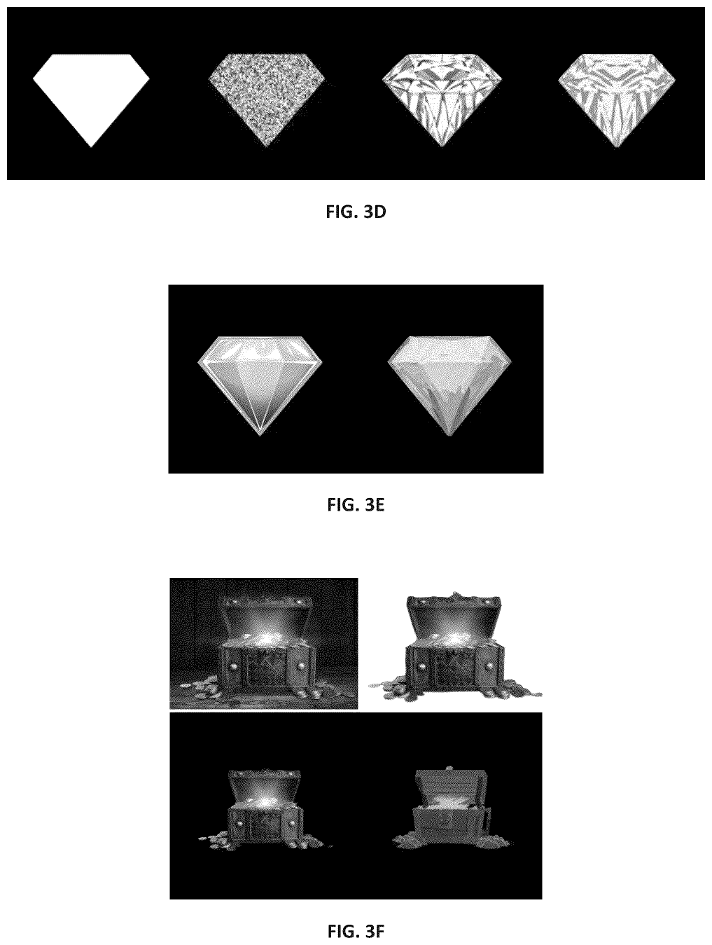

FIG. 3A is screenshot of an example of converting text to an image. Here, the words “a photo of a cat” results in a photorealistic image of a cat being returned (e.g., from an AI generative model).

FIG. 3B is a diagram of a conversion of a first image into a second image. Here, the words “a photo of a rainbow-colored chicken” results in a conversion of the first image to the second image (e.g., by an AI generative model).

FIG. 2 presents a sequence for transforming a photorealistic image into a stylized sprite, beginning with the removal of the background. This step allows for isolating the subject from its surroundings, facilitating subsequent manipulations. The image is then repositioned onto a uniform background, ensuring a consistent visual field that aids in the uniform application of artistic styles. A generative AI model pre-trained with a desired art style is loaded, preparing the system for the style application process. The image, now set against a standardized backdrop, is processed through this model, where the AI applies the predefined artistic nuances, effectively reinterpreting the original photorealism into the chosen stylistic expression. The output from the generative model is received, displaying the image with the newly applied art style. The background is once again removed, yielding a sprite that is ready for use in various digital environments. This sequence not only streamlines the conversion of photorealistic images to artistically styled sprites, but also ensures that the final outputs are optimized for immediate application in game development, digital animation, or other multimedia projects.

FIG. 3C is a diagram of a conversion of a text and mask to a single subject image or sprite. In a first pass, input of “a hamburger” results in a hamburger mask being returned (e.g., by an AI generative model). The hamburger mask is filled with noise. An image-to-image conversion is applied (e.g., by the AI generative model) to produce a photorealistic image of a hamburger, which may be placed within the mask. In an optional second pass, an image-to-image conversion is applied (e.g., by the generative model) to convert the image to a specific style, such as “a hamburger in the style of dragon crashers”; and the background may be removed, resulting in a ready-to-use sprite. In accordance with an embodiment, an additional pass may be used to modify only a part of the hamburger image; for example by drawing a mask shaped like a flag on top of the burger bun, the flag mask filled with noise, and the image-to-image conversion being applied to generate an image of a flag, which may be placed within the flag mask on the hamburger image (e.g., using compositing).

FIG. 3D is a diagram of a flow for generating a photo-realistic image with a particular style, in accordance with some embodiments. A mask and a text prompt (e.g., “a photo of a diamond”) is received and a corresponding image (e.g., see the first image) is generated. The mask is filled with noise (e.g., see the second image). The color the noise may cause different effects on the final output. For example, brighter noise may produce brighter outputs. Using only specific colors in the noise may cause outputs to be weighted towards those colors. A photorealistic image is generated from the noise image and the prompt (e.g., see the third image). The photorealistic image may be generated again using a second machine-learning model that has been trained on the user's art style (e.g., see the fourth image).

FIG. 3E is a diagram of a flow for creating similar variations of a sprite in a particular style or converting an input image to a particular style, in accordance with some embodiments. A sprite and a text prompt are received. The sprite is resized to fit in an image having a geometric shape (e.g., a square) and the background of the shape is filled with a background (e.g., a mono-color black background) (e.g., see the first image). A secondary machine-learned model trained on a particular style is used directly with the input sprite to convert other styles to the particular style, create similar variations of the sprite in the particular style, or convert a photorealistic input image into the particular style.

FIG. 3F is a diagram of a flow for extracting a subject from an image and converting it to a particular style, in accordance with some embodiments. A photo and a text prompt identifying a subject of the photo are received. Or a subject of the photo is automatically detected from the photo such that the text prompt identifying the subject is optional. The subject is extracted automatically (e.g., using a machine-learning model trained to identify the subject). The extracted subject is placed onto a background (e.g., a mono-color black background). The image is then converted into a particular style, as discussed herein.

FIG. 3A through FIG. 3F illustrate a comprehensive suite of transformations using generative AI models to convert textual prompts, masks, and existing images into stylized digital images and sprites, suitable for various digital media applications. In FIG. 3A, the process initiates with a simple textual input, ‘a photo of a cat,’ which the AI model uses to generate a corresponding photorealistic image, demonstrating the model's capability to accurately interpret and visualize textual descriptions. FIG. 3B extends this capability, where the input ‘a photo of a rainbow-colored chicken’ prompts the AI to apply vibrant, multicolored transformations to an existing image, showcasing the model's adeptness in dynamic color adjustments based on textual cues.

FIG. 3C introduces a user-defined mask combined with the text ‘a hamburger.’ The mask is filled with noise to provide textural data, which the AI processes to render a photorealistic image of a hamburger. This image can optionally be transformed into a specific style, such as ‘a hamburger in the style of dragon crashers,’ through a secondary AI model application, illustrating the model's versatility in artistic reinterpretation. The process concludes with background removal, preparing the sprite for diverse digital uses.

Expanding further, FIG. 3D demonstrates a process where a mask and a text prompt, ‘a photo of a diamond,’ lead to the generation of a photorealistic image with potential for subsequent style-specific re-rendering using noise variations to influence visual output characteristics. FIG. 3E shows how a sprite and a text prompt can be used to create variations of the sprite in a specific style or convert an input image to that style, highlighting the model's utility in consistent style application across different assets. Lastly, FIG. 3F details a method for extracting a subject from a photo, enhancing it with a specific style, and placing it onto a mono-color background, ready for use as a stylized digital asset.

Together, these figures provide a robust framework for generating, transforming, and stylizing digital images from a combination of textual, graphical, and photographic inputs, significantly enhancing content creation workflows.

In example embodiments, the various machine-learning algorithms or models generated and/or used herein may include one or more machine-learning algorithms or models for generating images (e.g., images having a photorealism that transgresses a minimum photorealism threshold), identifying a subject within an image (e.g. with a certain percentage of accuracy that transgresses an accuracy threshold), generating masks corresponding to an image, generating noise (e.g., for filling in masks), generating backgrounds (e.g., mono-color backgrounds having a level of perfection that transgresses a background-perfection threshold), and/or applying one or more particular styles to an image, such as styles having one or more non-photo-realistic, fanciful, or other features.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. For example, subjects identified in images may be placed on background having various different geometric shapes or on backgrounds having different colors, different noise patterns; different colors or patterns may be used as noise, and so on, based on, for example, whether one or more such transformations increase a quality of the output data (e.g., with respect to or more thresholds or other metrics). The continuously updated and retrained artificial intelligence agents may then be applied to subsequent novel input data to generate one or more of the outputs described herein.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

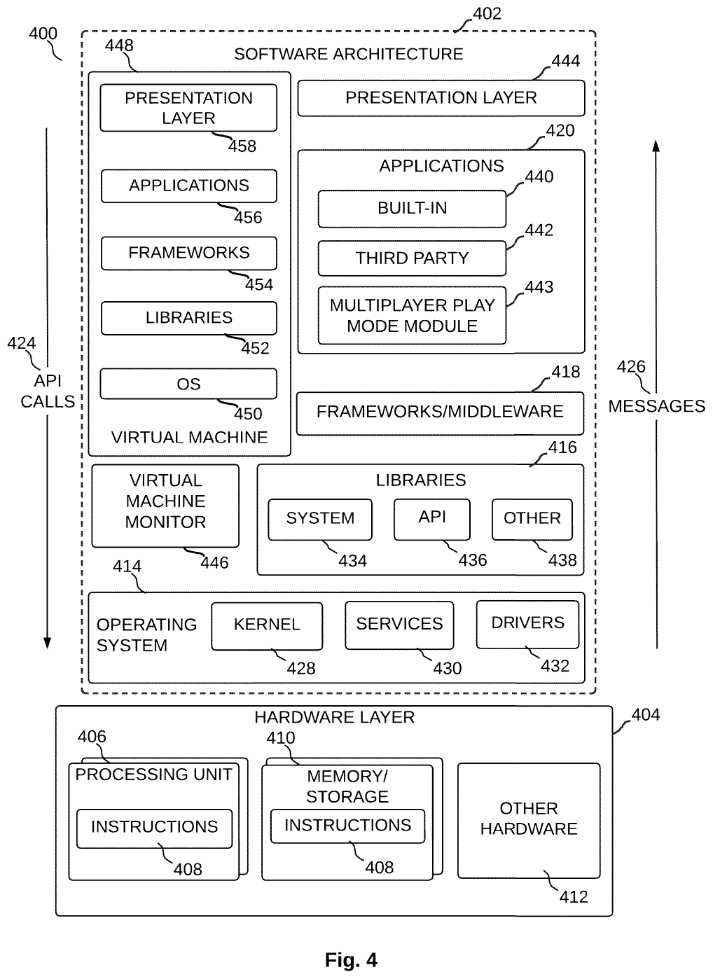

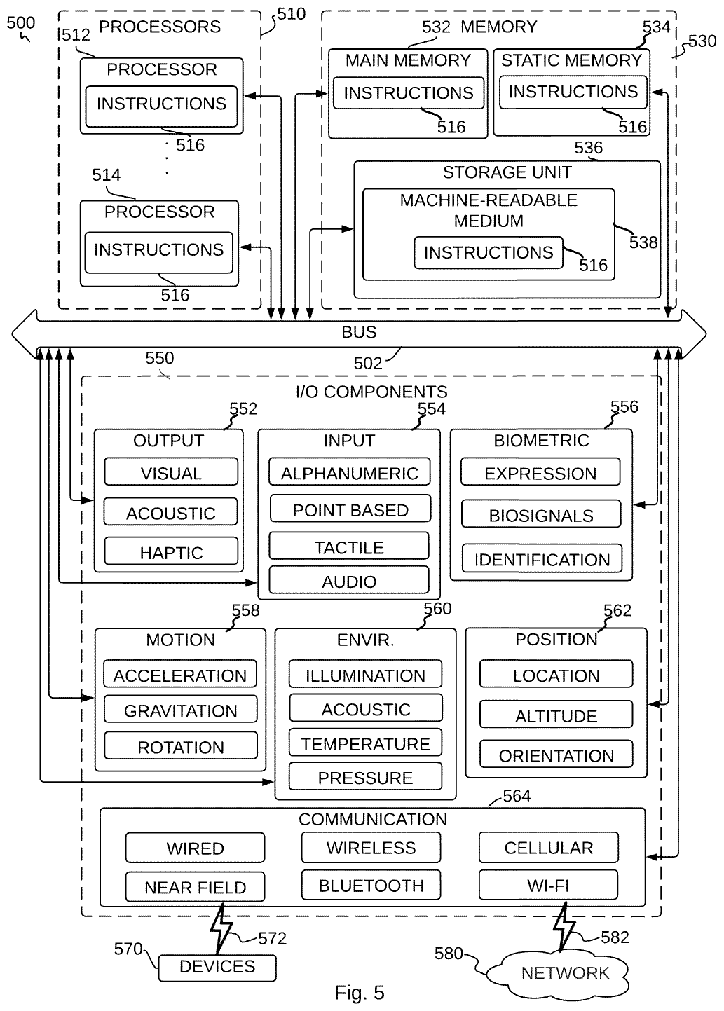

FIG. 4 is a block diagram 400 illustrating an example software architecture 402, which may be used in conjunction with various hardware architectures herein described to provide a gaming engine and/or components of the interactive tile-based ML terrain generation system. FIG. 4 is a non-limiting example of a software architecture and it will be appreciated that many other architectures may be implemented to facilitate the functionality described herein. The software architecture 402 may execute on hardware such as a machine 500 of FIG. 5 that includes, among other things, processors 510, memory 530, and input/output (I/O) components 550. A representative hardware layer 404 is illustrated and can represent, for example, the machine 500 of FIG. 5. The representative hardware layer 404 includes a processing unit 406 having associated executable instructions 408. The executable instructions 408 represent the executable instructions of the software architecture 402, including implementation of the methods, modules and so forth described herein. The hardware layer 404 also includes memory/storage 410, which also includes the executable instructions 408. The hardware layer 404 may also comprise other hardware 412.

In the example architecture of FIG. 4, the software architecture 402 may be conceptualized as a stack of layers where each layer provides particular functionality. For example, the software architecture 402 may include layers such as an operating system 414, libraries 416, frameworks or middleware 418, applications 420 and a presentation layer 444. Operationally, the applications 420 and/or other components within the layers may invoke application programming interface (API) calls 424 through the software stack and receive a response as messages 426. The layers illustrated are representative in nature and not all software architectures have all layers. For example, some mobile or special purpose operating systems may not provide the frameworks/middleware 418, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 416 may provide a common infrastructure that may be used by the applications 420 and/or other components and/or layers. The libraries 416 typically provide functionality that allows other software modules to perform tasks in an easier fashion than to interface directly with the underlying operating system 414 functionality (e.g., kernel 428, services 430 and/or drivers 432). The libraries 516 may include system libraries 434 (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) provide a higher-level common infrastructure that may be used by the applications 420 and/or other software components/modules. For example, the frameworks/middleware 418 may provide various graphic user interface (GUI) functions, high-level resource management, high-level location services, and so forth. The frameworks/middleware 418 may provide a broad spectrum of other APIs that may be utilized by the applications 420 and/or other software components/modules, some of which may be specific to a particular operating system or platform.

The applications 420 include built-in applications 440 and/or third-party applications 442. Examples of representative built-in applications 440 may include, but are not limited to, a contacts application, a browser application, a book reader application, a location application, a media application, a messaging application, and/or a game application. Third-party applications 442 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 442 may invoke the API calls 424 provided by the mobile operating system such as operating system 414 to facilitate functionality described herein. Applications 420 may include an interactive tile-based ML terrain generation module 443 which may implement the interactive tile-based ML terrain generation method 100 described in at least FIG. 1A.

The applications 420 may use built-in operating system functions (e.g., kernel 428, services 430 and/or drivers 432), libraries 416, or frameworks/middleware 418 to create user interfaces to interact with users of the system. Alternatively, or additionally, in some systems, interactions with a user may occur through a presentation layer, such as the presentation layer 444. In these systems, the application/module “logic” can be separated from the aspects of the application/module that interact with a user.

Some software architectures use virtual machines. In the example of FIG. 4, this is illustrated by a virtual machine 448. The virtual machine 448 creates a software environment where applications/modules can execute as if they were executing on a hardware machine (such as the machine 500 of FIG. 5, for example). The virtual machine 448 is hosted by a host operating system (e.g., operating system 414) and typically, although not always, has a virtual machine monitor 446, which manages the operation of the virtual machine 448 as well as the interface with the host operating system (i.e., operating system 414). A software architecture executes within the virtual machine 448 such as an operating system (OS) 450, libraries 452, frameworks 454, applications 456, and/or a presentation layer 458. These layers of software architecture executing within the virtual machine 448 can be the same as corresponding layers previously described or may be different.

FIG. 5 is a block diagram illustrating components of a machine 500, according to some example embodiments, configured to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. As such, the instructions 516 may be used to implement modules or components described herein. The instructions transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines that individually or jointly execute the instructions 516 to perform any one or more of the methodologies discussed herein.

The machine 500 may include processors 510, memory 530, and input/output (I/O) components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that may execute the instructions 516. The term “processor” is intended to include multi-core processor that may comprise two or more independent processors (sometimes referred to as “cores”) that may execute instructions contemporaneously. Although FIG. 5 shows multiple processors, the machine 500 may include a single processor with a single core, a single processor with multiple cores (e.g., a multi-core processor), multiple processors with a single core, multiple processors with multiples cores, or any combination thereof.

The memory/storage 530 may include a memory, such as a main memory 532, a static memory 534, or other memory, and a storage unit 536, both accessible to the processors 510 such as via the bus 502. The storage unit 536 and memory 532, 534 store the instructions 516 embodying any one or more of the methodologies or functions described herein. The instructions 516 may also reside, completely or partially, within the memory 532, 534, within the storage unit 536, within at least one of the processors 510 (e.g., within the processor's cache memory), or any suitable combination thereof, during execution thereof by the machine 500. Accordingly, the memory 532, 534, the storage unit 536, and the memory of processors 510 are examples of machine-readable media 538.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific input/output (I/O) components 550 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 550 may include many other components that are not shown in FIG. 5. The input/output (I/O) components 550 are grouped according to functionality merely for simplifying the following discussion and the grouping is in no way limiting. In various example embodiments, the input/output (I/O) components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 550 may include communication components 564 operable to couple the machine 500 to a network 580 or devices 570 via a coupling 582 and a coupling 572 respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 562, such as, location via Internet Protocol (IP) geo-location, location via Wi-Fi® signal triangulation, location via detecting a NFC beacon signal that may indicate a particular location, and so forth.

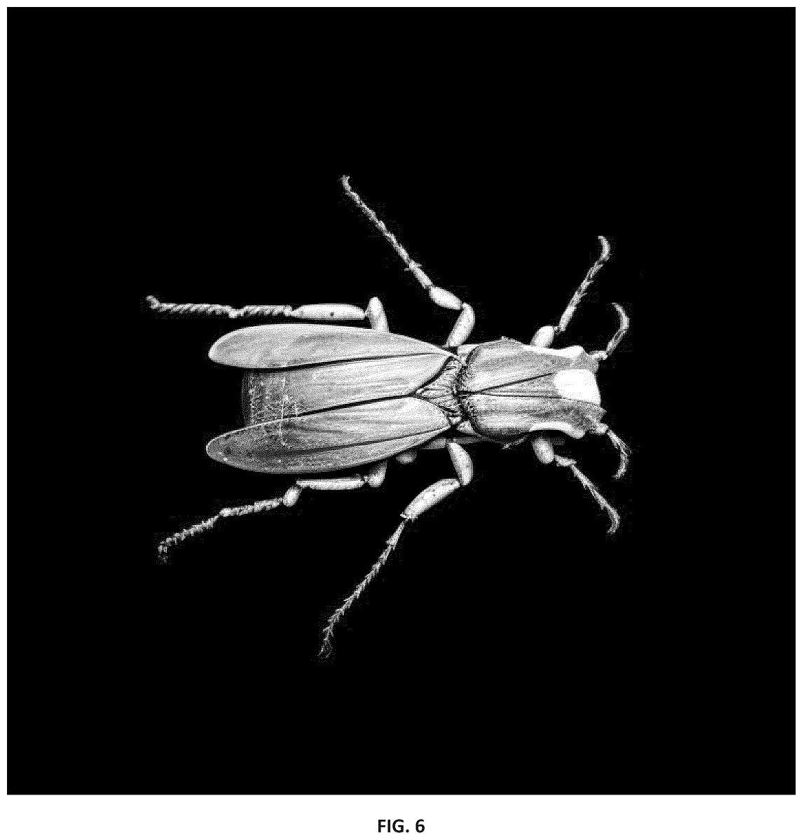

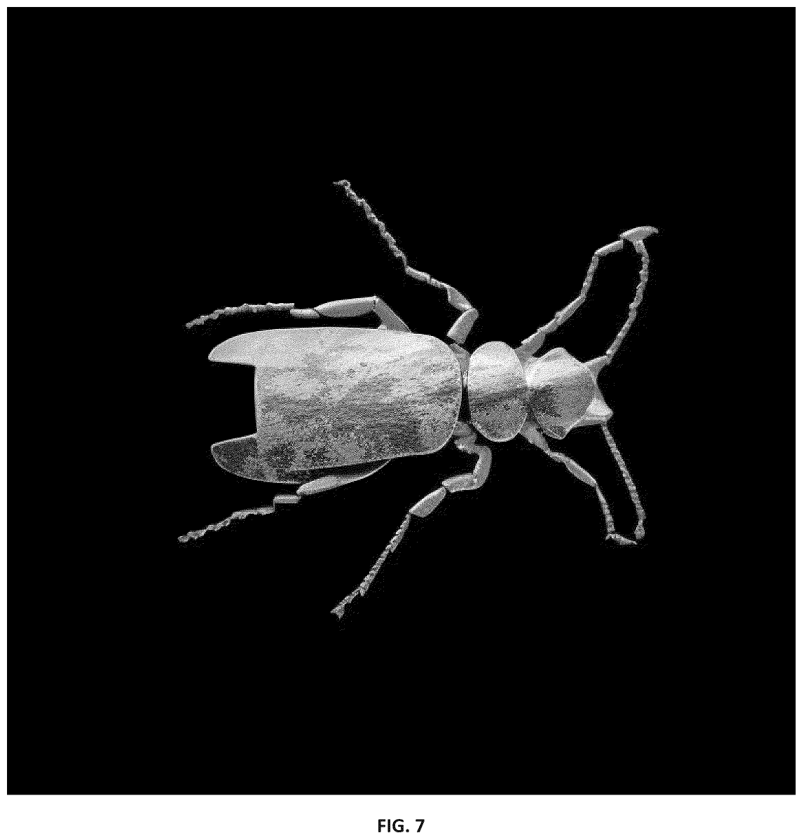

FIG. 6 is an example photorealistic image generated using one or more of the operations described herein.

FIG. 7 is the example photorealistic image of FIG. 6 with a particular style applied using one or more of the operations described herein.

FIG. 6 and FIG. 7 illustrate the advanced capabilities of the generative AI model in producing and enhancing photorealistic images. FIG. 6 presents an example of a photorealistic image generated by the AI model, based on predefined inputs and processing parameters. This image serves as a baseline demonstration of the model's ability to synthesize visually accurate representations from textual or graphical prompts.

Transitioning to FIG. 7, the same photorealistic image from FIG. 6 undergoes a stylistic transformation, where a specific art style is applied using a secondary machine-learning model trained on that style. This transformation exemplifies the model's flexibility in not only creating high-fidelity images but also adapting these images to various artistic expressions without compromising on detail or realism. The resultant image showcases a seamless integration of the original photorealistic elements with the applied artistic style, ready for use in digital media applications where style consistency across different visual elements is crucial.

Together, FIG. 6 and FIG. 7 provide a depiction of the model's end-to-end capability from generating base photorealistic images to applying complex artistic styles.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

The term ‘content’ used throughout the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is understood to include any object of digital nature, digital structure or digital element within an environment. A digital object can represent (e.g., in a corresponding data structure) almost anything within the environment, including, for example, 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

What is claimed is:

1. A non-transitory computer-readable storage medium storing a set of instructions that, when executed by one or more computer processors, causes the one or more computer processors to perform operations, the operations comprising:
receiving a mask and descriptive text associated with a subject, wherein the descriptive text comprises a text prompt;
resizing the mask to fit within a bounding box and placing the resized mask on a background image;
filling the mask with noise; and
receiving output of an image of the subject on a solid background from a generative AI model in response to a passing of a request to the generative AI model, the request including the noise-filled mask and the descriptive text.

2. The non-transitory computer-readable storage medium of claim 1, the operations further comprising regenerating the image with a specific art style applied based on an applying of a secondary machine-learning model trained on the specific art style to the image.

3. The non-transitory computer-readable storage medium of claim 2, the operations further comprising generating a ready-to-use sprite based on a removing of the solid background from the image with the specific art style applied.

4. The non-transitory computer-readable storage medium of claim 1, the operations further comprising analyzing the solid background of the image to ensure that one or more pixels included in the solid background are within a configurable range of a target color, thereby achieving a substantially-perfect background that is visually indistinguishable from the target color within a predetermined or configurable background-perfection threshold.

5. The non-transitory computer-readable storage medium of claim 1, the operations further comprising identifying and extracting the subject from an input image using a machine-learning model trained for subject recognition within the input image.

6. The non-transitory computer-readable storage medium of claim 1, further comprising generating of the noise, the generating of the noise including applying noise patterns to the mask using a machine-learning algorithm trained to generate noise that causes different effects on the output of the image.

7. The non-transitory computer-readable storage medium of claim 1, the operations further comprising Iteratively training one or more artificial intelligence agents using a plurality of sets of input data, wherein each set of the plurality of sets of input data is transformed and used to retrain the one or more artificial intelligence agents to increase a quality of the output.

8. The non-transitory computer-readable storage medium of claim 1, the operations further comprising adjusting one or more properties of the noise applied to the mask based on one or more criteria to influence one or more characteristics of the image.

9. The non-transitory computer-readable storage medium of claim 1, the operations further comprising selecting a target color for the solid background that complements the subject of the image to enhance an aesthetic quality of the image.

10. The non-transitory computer-readable storage medium of claim 1, the operations further comprising providing for iterative refinement of input parameters via a user interface, the user interface providing for adjustment of the noise-filled mask and the descriptive text.

11. A method comprising:
receiving a mask and descriptive text associated with a subject, wherein the descriptive text comprises a text prompt;
resizing the mask to fit within a bounding box and placing the resized mask on a background image;
filling the mask with noise; and
receiving output of an image of the subject on a solid background from a generative AI model in response to a passing of a request to the generative AI model, the request including the noise-filled mask and the descriptive text.

12. The method of claim 11, further comprising regenerating the image with a specific art style applied based on an applying of a secondary machine-learning model trained on the specific art style to the image.

13. The method of claim 12, further comprising generating a ready-to-use sprite based on a removing of the solid background from the image with the specific art style applied.

14. The method of claim 11, further comprising analyzing the solid background of the image to ensure that one or more pixels included in the solid background are within a configurable range of a target color, thereby achieving a substantially-perfect background that is visually indistinguishable from the target color within a predetermined or configurable background-perfection threshold.

15. The method of claim 11, further comprising identifying and extracting the subject from an input image using a machine-learning model trained for subject recognition within the input image.

16. The method of claim 11, further comprising generating of the noise, the generating of the noise including applying noise patterns to the mask using a machine-learning algorithm trained to generate noise that causes different effects on the output of the image.

17. A system comprising:
one or more computer processors;
one or more computer memories;
a set of instructions stored in the one or more computer memories, the set of instructions configuring the one or more computer processors to perform operations, the operations comprising:
receiving a mask and descriptive text associated with a subject, wherein the descriptive text comprises a text prompt;
resizing the mask to fit within a bounding box and placing the resized mask on a background image;
filling the mask with noise; and
receiving output of an image of the subject on a solid background from a generative AI model in response to a passing of a request to the generative AI model, the request including the noise-filled mask and the descriptive text.

18. The system of claim 17, the operations further comprising regenerating the image with a specific art style applied based on an applying of a secondary machine-learning model trained on the specific art style to the image.

19. The system of claim 18, the operations further comprising generating a ready-to-use sprite based on a removing of the solid background from the image with the specific art style applied.

20. The system of claim 17, the operations further comprising analyzing the solid background of the image to ensure that one or more pixels included in the solid background are within a configurable range of a target color, thereby achieving a substantially-perfect background that is visually indistinguishable from the target color within a predetermined or configurable background-perfection threshold.
